(19) United States
(12) Patent Application Publication
(10) Pub. No.: US 2015/0189960 A1
(43) Pub. Date: Jul. 9, 2015

(54) WATERPROOF APERTURED SURFACES OR MATERIALS USING NANOPARTICLE HYDROPHOBIC TREATMENTS

(71) Applicants: Mark D. Shaw, Jacksonville, FL (US); Mathew P. Clancy, St. Johns, FL (US)

(72) Inventors: Mark D. Shaw, Jacksonville, FL (US); Mathew P. Clancy, St. Johns, FL (US)

(21) Appl. No.: 14/661,506

(22) Filed: Mar. 18, 2015

Related U.S. Application Data
(63) Continuation-in-part of application No. 14/538,336, filed on Nov. 11, 2014.
(60) Provisional application No. 61/902,441, filed on Nov. 11, 2013.
(60) Provisional application No. 61/978,028, filed on Apr. 10, 2014.

(51) Int. Cl. A45B 25/18; B32B 38/08; B32B 37/18; B32B 5/02; B32B 3/26

(52) U.S. Cl. CPC A45B 25/18; B32B 5/028; B32B 3/266; B32B 37/18; B32B 38/08; B32B 2250/02; B32B 2255/02; B32B 2307/7265; B32B 2307/73; B32B 2459/00

(57) ABSTRACT

A method of manufacturing waterproof apertured materials or surfaces using nanoparticle hydrophobic compositions and treatments, and preferably superhydrophobic compositions and treatments, wherein apertures of a size that would normally render the surface or material water-permeable may be provided in the surface or material. The method comprises determining the extent of the hydrophobic field that extends beyond the physical edge of a particular treated intersecting member interwoven to form the material to determine the allowable size of an aperture, such that the extended hydrophobic field present on the intersecting members surrounding an aperture will be sufficient to prevent surface wetting and water permeability by fully overlapping the aperture or by presenting a reduced area effective aperture that precludes passage of water. In certain embodiments, the apertured material is provided with a liquid impermeable backing layer.

This application is a continuation-in-part of U.S. patent application Ser. No. 14/538,336, filed Nov. 11, 2014, claiming the benefit of U.S. Provisional Patent Application Ser. No. 61/902,441, filed Nov. 11, 2013, and U.S. Provisional Patent Application Ser. No. 61/978,028, filed Apr. 10, 2014, the disclosures of all being incorporated by reference herein.

### BACKGROUND OF THE INVENTION

This application relates generally to the field of waterproofing, and more particularly to the field of waterproofing normally permeable apertured surfaces or materials, and even more particularly to the field of waterproofing materials using nanotechnology coatings or chemical compositions and treatments.

Many common materials are not waterproof, either because their material of composition absorb liquids or because of apertures present in the material that are of sufficient size to allow penetration of water or other liquids. Some materials, such as common woven fabrics for example, are often composed of materials which absorb liquids and which contain apertures as a result of the weaving process. It has long been known to treat such materials with waterproofing materials, such as for example waxes, rubber coatings, or polymer coatings represented in well-known manner by PTFE-based SCOTCHGARD brand water repellent material. Recently, advances in nanotechnology have produced coatings or solutions which impart extreme hydrophobic properties to the materials to which they are applied by providing specialized nanoparticles in the coatings or solutions. The term hydrophobic is used for surfaces having water contact angels greater than about 120 degrees, and the term superhydrophobic is used for surfaces having water contact angles of greater than about 150 degrees. The nanoparticle technology often provides oleophobic and other non-aqueous liquid barriers as well as creating a hydrophobic barrier.

Examples of various hydrophobic and superhydrophobic compositions and treatment methodologies are provided in U.S Patent Publication Nos. 2013/0109261, 2012/0009396, 2010/0314575, 2012/0045954, and 2006/0029808, and also in U.S. Pat. Nos. 8,007,638, 6,103,379, 6,645,569, 6,743,467, 7,985,451, 8,187,707, 8,202,614, 7,998,554, 7,989,619, 5,042,991, 8,361,176, 8,258,206 and 6,723,378, and also in International Publication No. WO2013/058843, the disclosures of which are incorporated herein by reference. An example of a commercially available superhydrophobic coating is sold under the brand ULTRA EVER DRY by UltraTech International, Inc.

In materials such as woven fabrics having relatively small apertures between the intersecting threads or yarns, i.e., the apertures are smaller than the widths of the intersecting members, it has proven relatively easy to create waterproof surfaces using known waterproofing technology. As the apertures increase in size relative to the diameters of the threads, however, it becomes more difficult to create a waterproof fabric utilizing known waterproofing technology. As for woven or intersecting materials that are designated as screens or meshes, or any other materials that have inherent apertures that are of sufficient size to allow water passage directly or by wicking through the material, waterproofing using the known technology is not possible. Another problem in creating a woven fabric that is waterproof arises due to intrusion of connecting members or the like passing through the material, such as occurs for example with stitching or lacing passed through fabrics or leather.

It is an object of this invention to provide waterproof apertured materials or surfaces composed of intersecting members and a method for waterproofing such apertured materials or surfaces, using nanoparticle hydrophobic coatings or treatments, wherein the apertures defined by intersecting members are of greater width than the individual intersecting members. It is a further object to provide such waterproof materials or surfaces wherein the aperture size is sufficient such that the material or surface only minimally interferes with the passage of air or wind through the material or surface.

It is a further object to provide a method for waterproofing materials or surfaces having intrusive or breeching members passing through the waterproof material or surface, wherein the intrusive members are treated with a nanoparticle hydrophobic coating or treatment.

It is a further object to provide a waterproof material assembly comprising the combination of an apertured woven material and a liquid impermeable backing layer, the apertured woven material being treated with a hydrophobic treatment such that it is waterproof to liquids contacting the apertured woven material at low force, but wherein the apertured woven material is not waterproof when the liquid contacts at a higher force, such that the impermeable backing layer blocks passage of the liquid, and wherein the assembly is sufficiently hydrophobic such that no liquid is absorbed into the woven material and all liquid is easily shed from the assembly.

### SUMMARY OF THE INVENTION

The invention comprises a method of providing waterproof apertured materials or surfaces using hydrophobic nanoparticle compositions and treatments, and preferably superhydrophobic compositions and treatments, and the materials or surfaces resulting therefrom, wherein apertures of a size that would normally render the surface or material water-permeable may be provided in the surface or material, and further wherein intrusive or breeching members, such as stitching threads, laces, strings, shoestrings or the like, may pass through a waterproof surface or material without reducing the impermeability to water.

For open or unfilled apertures, the method comprises determining the extent of the hydrophobic field that extends beyond the physical edge of a particular treated material to determine the allowable size of the aperture, such that the extended hydrophobic field present on the material surrounding the aperture will be sufficient to prevent surface wetting and water permeability by fully overlapping the aperture or by presenting a reduced area effective aperture that is small enough to preclude passage of water.

Expressed in other terms, the invention embodies a method of manufacturing an apertured waterproof mesh material comprising the steps of interweaving intersecting members to form a mesh material comprising apertures of a size such that said mesh material is not waterproof; treating said intersecting members with a nanoparticle hydrophobic or superhydrophobic composition to create a hydrophobic field extending beyond said intersecting members and into each of said apertures such that the effective size of each of said apertures is reduced to a size that precludes passage of water through said apertures; or in other terms a method of manufacturing an apertured waterproof mesh material comprised of intersecting members, the method comprising the steps of treating said intersecting members with a nanoparticle hydrophobic or superhydrophobic composition to create a hydrophobic field extending beyond said intersecting members; determining the extent of said hydrophobic field; interweaving intersecting members to form a mesh material having apertures wider than the width of each of said intersecting members, such that said hydrophobic field extends a sufficient distance into said apertures to preclude passage of water through said apertures; or in other terms a method of manufacturing an apertured waterproof mesh material comprised of intersecting members, the method comprising the steps of treating said intersecting members with a nanoparticle hydrophobic or superhydrophobic composition to create a hydrophobic field extending beyond said intersecting members; determining the extent of said hydrophobic field; interweaving intersecting members to form a mesh material having apertures of a size that would be water permeable but for said treating step, whereby said hydrophobic fields extending into each of said apertures precludes passage of water through said aperture. Additionally, it is a method wherein said intersecting members are treated prior to said interweaving step; or wherein said intersecting members are treated after said interweaving step; and/or wherein said step of interweaving intersecting members produces apertures of a size such that said hydrophobic fields of said intersecting members adjacent said apertures extend completely across said apertures; and/or wherein said step of interweaving intersecting members produces apertures of a size such that said hydrophobic fields of said intersecting members adjacent said apertures extend partially into said apertures a sufficient distance to define effective apertures that preclude passage of water through said apertures.

Also, the invention embodies an apertured waterproof mesh material produced by the above methods.

For filled apertures extending through waterproof materials that receive breeching members, such as for example apertures produced by stitching or to receive a lace or similar elongated member, the breeching member is first treated with a nanoparticle hydrophobic composition, such that wicking through the breeching member is precluded and the aperture is effectively blocked by the hydrophobic field, thereby maintaining liquid impermeability of the waterproof material.

In other embodiments, the invention embodies a waterproof material assembly, and its method of manufacture, comprising the combination of an apertured woven material and a liquid impermeable backing layer, the apertured woven material being treated with a hydrophobic treatment such that it is waterproof to liquids contacting the apertured woven material at low force, but wherein the apertured woven material is not waterproof when the liquid contacts at a higher force, such that the impermeable backing layer blocks passage of the liquid, and wherein the assembly is sufficiently hydrophobic such that no liquid is absorbed into the woven material and all liquid is easily shed from the assembly. Such an assembly may be utilized for example as the fabric for an umbrella.

In alternative language, the other embodiments comprise a method of manufacturing a waterproof material assembly comprising the steps of interweaving intersecting members to form a mesh material layer comprising apertures of a size such that said mesh material layer is not waterproof; treating said intersecting members with a nanoparticle hydrophobic or superhydrophobic composition to create a hydrophobic field extending beyond said intersecting members and into each of said apertures such that the effective size of each of said apertures is reduced to a size that precludes passage of the majority of said water through said apertures; and joining a liquid impermeable backing layer to said mesh material layer; whereby water striking said mesh material layer with sufficient force such that a portion of said water passes through said apertures is prevented from passing through said assembly by said backing layer.

In other terms, a method of manufacturing a waterproof mesh material assembly comprised of intersecting members, the method comprising the steps of treating said intersecting members with a nanoparticle hydrophobic or superhydrophobic composition to create a hydrophobic field extending beyond said intersecting members; determining the extent of said hydrophobic field; interweaving intersecting members to form a mesh material layer having apertures wider than the width of each of said intersecting members, said mesh material layer characterized in that said mesh material layer is completely waterproof for water striking said mesh material layer at a force less than X and said mesh material is partially waterproof for water striking said mesh layer at a force greater than X; joining a liquid impermeable backing layer to said mesh material layer such that said assembly is completely waterproof.

Alternatively, embodiments of the invention comprise a waterproof mesh material assembly comprising a mesh material layer of intersecting members treated with a nanoparticle hydrophobic or superhydrophobic composition, thereby creating a hydrophobic field extending beyond said intersecting members, said intersecting members defining apertures; and a liquid impermeable backing layer joined to said mesh material layer; wherein the size of said apertures is not sufficiently small such that a portion of water striking said mesh material layer with sufficient force passes through said apertures but is prevented from passing through said assembly by said backing layer.

An exemplary example of a device incorporating the apertured mesh material is an umbrella, wherein the ability to provide apertures of larger diameter which still maintain waterproof characteristics may provide for an umbrella less likely to invert in strong winds, the apertures providing passage for the wind through the mesh material. Alternatively, an umbrella incorporating the mesh material assembly with the liquid impermeable backing layer presents an umbrella that readily sheds water from its surface, such that the water is thoroughly removed prior to bringing the umbrella into a building.

### BRIEF DESCRIPTION OF THE DRAWINGS

FIG. 1 is an illustration of an apertured material composed of intersecting members having been treated to produce a hydrophobic surface and showing the extended hydrophobic field sufficient to maintain liquid impermeability.

FIG. 2 illustrates a breeching member extending through a waterproof material.

FIG. 3 illustrates an apertured material composed of intersecting members having been treated to produce a hydrophobic surface in combination with a liquid impermeable backing layer.

### DETAILED DESCRIPTION OF THE INVENTION

With reference to the drawings, embodiments of the invention will now be described in detail. In general, the embodiments of the invention disclose a method of manufacturing an apertured mesh material composed of intersecting members defining apertures of sufficient size to be permeable to water, and treating said intersecting members before or after the step of intersecting the members with a nanoparticle hydrophobic, including superhydrophobic, composition that creates a hydrophobic field extending beyond the intersecting members and across and into the apertures, whereby the overlapping or adjacent hydrophobic fields preclude passage of water through said normally permeable apertures. For purposes of this disclosure, the term “mesh” or “mesh material” shall refer to and include a material, such as a fabric, screen or the like, composed of intersecting elongated members, such as threads, yarns, strings, wires, cables, rods or the like, which are woven or interwoven.

For purposes of this disclosure, hydrophobic or superhydrophobic compositions and treatments suitable for this invention shall include but not be limited to the compositions and treatments disclosed in U.S Patent Publication Nos. 2013/0109261, 2012/0009396, 2010/0314575, 2012/0045954, and 2006/0029808, and also in U.S. Pat. Nos. 8,007,638, 6,103,379, 6,645,569, 6,743,467, 7,985,451, 8,187,707, 8,202,614, 7,998,554, 7,989,619, 5,042,991, 8,361,176, 8,258,206 and 6,723,378, and also in International Publication No. WO2013/058843. The disclosure of these publications and patents as to the compositions and methods of application are incorporated herein by reference.

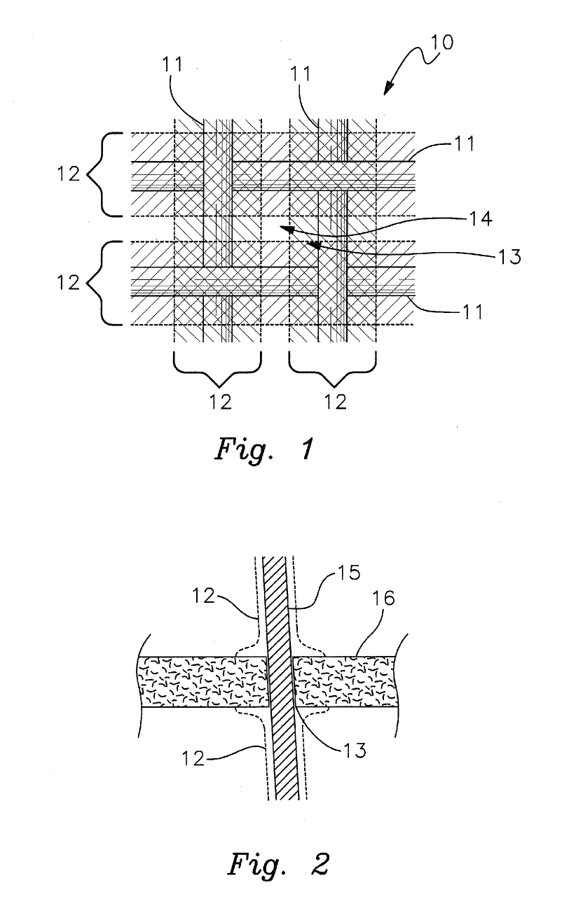

As shown in FIG. 1, an apertured mesh material or surface 10 is manufactured by interweaving a plurality of intersecting members 11, such as for example thread members combing to create a fabric. The intersecting members 11, and therefore the apertured mesh material 10 as well, is treated with a nanoparticle hydrophobic composition through either a coating process or an absorption process. For example, intersecting members 11 may be treated with a nanoparticle hydrophobic composition sold under the brand name ULTRA EVER DRY. The intersecting members 11 may be treated prior to the step of intersecting the members 11 to form the mesh material 10, or the intersecting members 11 may be inter woven together first to form the apertured material 10 and then treated. The treatment step does not physically block any portions of or reduce the actual size of the apertures 13.

The intersecting members 11 are interwoven to produce apertures 13 of a size that are permeable to water. More preferably, the apertures 13, which are generally square or rectangular in configuration, have width dimensions greater than the cross-sectional widths of the intersecting members 11, i.e., greater than the diameters of generally cylindrical intersecting members 11 for example. Apertures of such size are typically provided in mesh materials 10 that are designed to permit significant flow of air through the mesh material 10.

Application of the nanoparticle hydrophobic or superhydrophobic composition to the intersecting members 11 creates a hydrophobic field 12 (taken herein to include superhydrophobic fields as well) that extends beyond the actual physical edges of each of the intersecting members 11. The extent of the extended hydrophobic field 12 must be measured and known, as it is this extent that determines the maximum permissible size for an aperture 13. Properly chosen, the combination of the hydrophobic fields 12 associated with the portions of the intersecting members 11 defining an aperture 13 will combine, either because of overlapping or being sufficiently adjacent, to create a hydrophobic barrier either fully across the aperture 13 or sufficiently across the aperture 13 to create an effective aperture 14 sufficiently small in dimensions so as to preclude passage of water through the aperture 13, thereby producing a mesh material that is liquid impermeable. The extent of the hydrophobic field 12 will vary dependent upon the material of composition of the intersecting members 11 and the strength of the particular nanoparticle hydrophobic or superhydrophobic composition chosen. The hydrophobic can be measured for a particular intersecting member 11 can be measured by treating the intersecting member 11 and then varying the size of the interwoven aperture 13 to determine the maximum allowable size for the aperture 13 to remain waterproof.

In this manner, mesh materials such as fabrics, screens or the like may be manufactured that are water impermeable while still allowing passage of air through the apertures 13. The method thus comprises determining the extent of the hydrophobic field 12 that extends beyond the physical edge of a particular treated intersecting member 11 to determine the allowable maximum size of the aperture 13, such that the extended hydrophobic field 12 extending from the intersecting members 11 surrounding the aperture 13 will be sufficient to prevent surface wetting and water permeability by fully overlapping and extending across the aperture 13 or by extending sufficiently into the aperture 13 to create an effective aperture 14 of reduced area that is inherently small enough to preclude passage of water. An exemplary example of a device incorporating the apertured mesh material is an umbrella, wherein the ability to provide apertures of larger diameter which still maintain waterproof characteristics may provide for an umbrella less likely to invert in strong winds, the apertures providing passage of the wind through the mesh material.

In a second embodiment, an aperture 13 may be present in a waterproof material 16 for the purpose of receiving a breeching or member 15. The material 16 which may be naturally liquid impermeable or treated as discussed or referenced above, the breeching member 15 passing through either a pre-made hole or bore, such as a shoelace, tie or string passing through a pre-cut hole or a grommet in a leather material, or a hole or bore made during construction, such as a stitching thread passing through a fabric. In many instances the presence of the breeching member 15 in the aperture 13 may render the material 16 permeable to liquids, especially if the breeching member 15 is composed of a material susceptible to wicking, such as a shoelace or thread. To maintain liquid impermeability, the breeching member 15 is treated with a nanoparticle hydrophobic or superhydrophobic composition that creates a hydrophobic field 12, as shown in FIG. 2, such that the combination of the nanoparticle hydrophobic or superhydrophobic treatment and the hydrophobic field 12 preclude passage of liquid through the aperture 13 whether by wicking or capillary effect. More preferably, the material 16 is also treated with the nanoparticle hydrophobic or superhydrophobic composition such that the hydrophobic fields 12 will overlap to better seal the aperture 13.

While the terms “nanoparticle hydrophobic or superhydrophobic treatment and composition” have been used herein, it is to be understood that some of the nanoparticle hydrophobic or superhydrophobic treatments and compositions will also render the treated material impermeable to almost all liquids and oils, such that the effect is hydrophobic, liquid-phobic and oleophobic. The allowable presence of apertures in the liquid impermeable material, whether the apertures are present due to weaving manufacture, needling, apertures inherent in the material, apertures required for functionality of the object (e.g., a shoe), etc., enables surfaces, materials, coverings, garments or the like to be created, for example, that allow air passage through the material while maintaining impermeability. Such materials can be utilized for normal or protective clothing, shoes, covers, tents, canopies, umbrellas, etc. In addition to providing materials that are not wetted, the invention also provides such materials that may be termed “self-cleaning”, in that the material is not susceptible to common liquid stains and is more easily cleaned of solid or particulate matter. Most preferably even the inherently waterproof materials are treated so as to be hydrophobic.

The liquid impermeability of the apertured mesh material 10 composed of intersecting members 11 as shown in FIG. 1 may vary depending on the amount of force with which the liquid contacts the material 10. For example, a material 10 may be completely waterproof in circumstances where water or other liquids flow across the material 10 laterally, or where water in the form of a drip, spill, mist, drizzle or light rain contacts or strikes the surface of the material 10 at an angle but with insufficient force to overcome the effective aperture 14 created by the hydrophobic coating or treatment applied to the intersecting members 11. In contrast, in circumstances where the water strikes the material 10 with higher force, such as for example will be encountered when hard rain drops strike an umbrella, the force is sufficient to overcome the effective aperture size, and a small portion of the water may force itself through the apertures 13 in the form of a misting. This can be described by characterizing the mesh material 10 as being completely waterproof for water striking the surface of the material 10 at a force less than X, but being only partially waterproof for water striking the surface of the material 10 at a force greater than X.

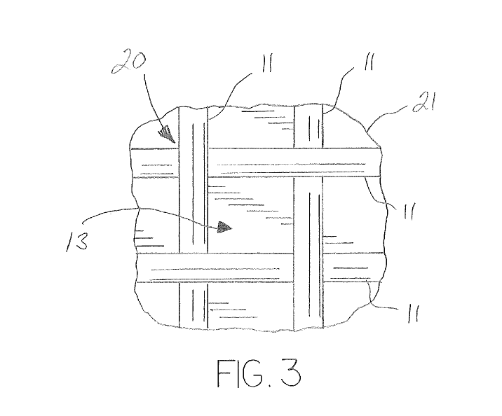

To account for this, the size of the apertures 13 may be reduced by increasing the diameter of the intersecting members 11 or by increasing the number of intersecting members 11 per square inch. This results however in significantly increased costs of manufacture, since the total volume or amount of intersecting members 11 is increased and the amount of the hydrophobic composition required to treat the intersecting members 11 is increased. A different solution to the problem, in keeping with the technology of this disclosure, is illustrated in FIG. 3, which shows a hydrophobically treated apertured mesh material layer 20 in combination with a thin, liquid impermeable backing layer 21. The backing layer 21 and apertured material layer 20 are co-extensively joined in conventional manner, such as by adhesive bonding, heat bonding, etc. The backing layer 21 comprises a relatively low cost polymer film manufactured in known manner such that it is impermeable to liquids without the need for additional treatment by a hydrophobic composition. The intersecting members 21 may be treated or coated before or after being interwoven.

The assembly created by the combination of the apertured material layer 20 and the liquid impermeable backing layer 21 allows the spacing of the intersecting members 11 and the apertures 13 formed thereby to be increased to a size wherein the effective aperture 14 would not be sufficient to prevent passage of small portions water through the apertured material layer 20 when the water strikes the apertured material layer 20 with a relatively high force. The presence of the liquid impermeable backing layer 21 prevents any intrusion or passage or water through the assembly, such that the assembly is therefore completely waterproof. The backing layer 21 may be extremely thin, to the extent that it would normally not be sufficiently resistant to tearing, since the apertured material layer 20 acts a reinforcing scrim and imparts sufficient structural integrity to the entire assembly, thus enabling the material cost of the backing layer 21 to be minimized.

In this manner the assembly may be utilized, for example in an umbrella, such that the umbrella is completely waterproof, while maintaining lower manufacturing costs due to the relatively inexpensive nature of the backing layer 21. Because of the hydrophobic nature of the treated apertured material layer 20, the surface of the assembly is not wetted by rain water and all water on the umbrella is shed by a simple shaking of the umbrella, such that no water remains to drip from the folded umbrella when it is brought into a building. The assembly is of course applicable in many other situations where similar properties are desired.

It is contemplated that equivalents and substitutions for certain elements set forth above may be obvious to those of skill in the art, and therefore the true scope and definition of the invention is to be as set forth in the following claims. The examples and embodiments described above and in the drawings are not meant to be limiting.

We claim:

1. A method of manufacturing a waterproof material assembly comprising the steps of:
interweaving intersecting members to form a mesh material layer comprising apertures of a size such that said mesh material layer is not waterproof;
treating said intersecting members with a nanoparticle hydrophobic or superhydrophobic composition to create a hydrophobic field extending beyond said intersecting members and into each of said apertures such that the effective size of each of said apertures is reduced to a size that precludes passage of the majority of said water through said apertures; and
joining a liquid impermeable backing layer to said mesh material layer;
whereby water striking said mesh material layer with sufficient force such that a portion of said water passes through said apertures is prevented from passing through said assembly by said backing layer.

2. The method of claim 1, wherein said intersecting members are treated prior to said interweaving step.

3. The method of claim 1, wherein said intersecting members are treated after said interweaving step.

4. The method of claim 1, wherein said step of interweaving intersecting members produces apertures of a size such that said hydrophobic fields of said intersecting members adjacent said apertures extend completely across said apertures.

5. The method of claim 1, wherein said step of interweaving intersecting members produces apertures of a size such that said hydrophobic fields of said intersecting members adjacent said apertures extend partially into said apertures a sufficient distance to define effective apertures that preclude passage of water through said apertures.

6. An apertured waterproof mesh material produced by the process of claim 1.

7. A method of manufacturing a waterproof mesh material assembly comprised of intersecting members, the method comprising the steps of:
treating said intersecting members with a nanoparticle hydrophobic or superhydrophobic composition to create a hydrophobic field extending beyond said intersecting members;
determining the extent of said hydrophobic field;
interweaving intersecting members to form a mesh material layer having apertures wider than the width of each of said intersecting members, said mesh material layer characterized in that said mesh material layer is completely waterproof for water striking said mesh material layer at a force less than X and said mesh material is partially waterproof for water striking said mesh layer at a force greater than X;
joining a liquid impermeable backing layer to said mesh material layer such that said assembly is completely waterproof.

8. The method of claim 7, wherein said intersecting members are treated prior to said interweaving step.

9. The method of claim 7, wherein said intersecting members are treated after said interweaving step.

10. The method of claim 7, wherein said step of interweaving intersecting members produces apertures of a size such that said hydrophobic fields of said intersecting members adjacent said apertures extend completely across said apertures.

11. The method of claim 7, wherein said step of interweaving intersecting members produces apertures of a size such that said hydrophobic fields of said intersecting members adjacent said apertures extend partially into said.

12. An apertured waterproof mesh material produced by the process of claim 7.

13. A waterproof mesh material assembly comprising:
a mesh material layer of intersecting members treated with a nanoparticle hydrophobic or superhydrophobic composition, thereby creating a hydrophobic field extending beyond said intersecting members, said intersecting members defining apertures; and
a liquid impermeable backing layer joined to said mesh material layer;
wherein the size of said apertures is not sufficiently small such that a portion of water striking said mesh material layer with sufficient force passes through said apertures but is prevented from passing through said assembly by said backing layer.

14. The assembly of claim 13, wherein said apertures are of a size such that said hydrophobic fields of said intersecting members adjacent said apertures extend completely across said apertures.

15. The assembly of claim 13, wherein said apertures are of a size such that said hydrophobic fields of said intersecting members adjacent said apertures extend partially into said apertures.

16. The assembly of claim 13, wherein said mesh material assembly is incorporated into an umbrella.

17. The assembly of claim 14, wherein said mesh material assembly is incorporated into an umbrella.

18. The assembly of claim 15, wherein said mesh material assembly is incorporated into an umbrella.

19. The assembly of claim 13, wherein said mesh material layer is characterized in that said mesh material layer is completely waterproof for water striking said mesh material layer at a force less than X and said mesh material is partially waterproof for water striking said mesh layer at a force greater than X.
